(19) United States
(12) Patent Application Publication
(10) Pub. No.: US 2004/0237329 A1
(43) Pub. Date: Dec. 2, 2004

(54) GARBAGE DRYING APPARATUS

(76) Inventor: Young Kwang Jang, Kwangju-City (KR)

Correspondence Address: Richard J Streit, Ladas & Parry, 224 South Michigan Avenue, Suite 1200, Chicago, IL, 60604, US

(21) Appl. No.: 10/487,410

(22) PCT Filed: Jul. 26, 2002
(86) PCT No.: PCT/KR02/01419

(30) Foreign Application Priority Data
Aug. 23, 2001 (KR) 2001/25572 U

(51) Int. Cl. F26B 11/02

(52) U.S. Cl. 34/128

(57) ABSTRACT

The present invention relates to garbage drying apparatus. The garbage drying apparatus comprises an inner rotary drum and an outer rotary drum; a roller rotatably supported by a guide roller formed on one end and driven by a chain belt connected to a motor so as to rotate by being connected to the other end of the outer surface of the outer rotary drum; a plurality of shaking vanes and shaking intercepts individually formed on the inner surfaces of the inner rotary drum and the outer rotary drum; and a discharging outlet for exhausting the dried garbage formed by drying the introduce garbage via a hopper with a heat of a burner, wherein a plurality of reflection-protective caps 130 and energy-saving plates 140 are formed within the inner rotary drum 100 in order to uniformly disperse the flame generated by the burner 500 into the inner rotary drum 100, and a plurality of sawteeth 150 in a straight line are protruded from the outer surface of the inner rotary drum 100 in the axis direction in order to uniformly grind the food waste falling from the outer rotary drum 200, thereby uniformly dispersing the flame generated from the burner into the inner surfaces of the inner rotary drum and the outer rotary drum, preventing the flame from being in contact with the garbage to be incinerated, and maximizing a drying effect of the garbage with small heat capacity by allowing the hot combustion gas together with the food waste to pass through the cylindrical drums to save the energy.

### TECHNICAL FIELD

The present invention relates to a garbage drying apparatus, and more particularly to a garbage drying apparatus comprising a plurality of reflection-protective caps and energy-saving plates within an inner rotary drum, thereby uniformly dispersing a flame generated from a burner into inner and outer rotary drums, preventing the flame from being in contact with the garbage to be incinerated, and maximizing a drying effect of the garbage with small heat capacity.

### BACKGROUND ART

As the industrial development raises the standard of human living, the consumption rate of various foods explosively increases, thereby increasing the subsequent garbage.

Further, as livestock husbandry is large-sized, the excrement of the livestock increases. This organic garbage including the excrement causes an environmental pollution. Therefore, the disposal of the organic garbage becomes a big issue.

Thus, various methods for more effectively disposing the aforementioned organic garbage and reusing it in an agricultural business have been recently developed. In these cases, a first step is a removal of moisture from the organic garbage. Moisture residue is a leading factor of the environmental pollution and hinders a long-term preservation.

Therefore, a rotary kiln type drying method comprising a cylindrical drum is the most ideal method for drying a large quantity of the garbage at a short term. As shown in FIG. 1, a conventional garbage drying apparatus comprises a supply unit 3 installed on a frame and having an upper hopper 2 for receiving compost; an inner rotary drum 6 having a plurality of shaking vanes 4 and shaking intercepts 5 stepwise formed on its inner surface to be spaced from each other by a designated interval in order to grind and mix the compost transferred through the supply unit 3 and to transfer and mix the compost in the clockwise direction; an outer rotary drum 7 of which a lower-outer surface is rotatably supported by the frame 1 and the inner rotary drum 6 is connected to the inner wall and having a plurality of shaking vanes 4′ and shaking intercepts 5′ stepwise formed on its inner surface to be spaced from each other by a designated interval in order to grind and mix the compost transferred through the inner rotary drum 6 and to transfer and mix the compost in the counter clockwise direction; a burner 8 installed on one side of the outer rotary drum 7 and serving to burn the compost introduced into the inner rotary drum 6 and the outer rotary drum 7 via the supply unit 3; a driving means 11 for gearing into a chain gear (not shown) installed on one end of the outer rotary drum 7 via a driving motor 9 and a chain 10 so as to rotate the outer rotary drum 7 and the inner rotary drum 6 in the same direction; and an exhaust means 16 installed on the frame 1 and the outer rotary drum 7 toward the supply unit 3 and having an exhaust pipe 13 formed on the upper surface and serving to exhaust gas generated by drying the compost via a fan 12 and an exhaust outlet formed on the lower surface and serving to exhaust the compost which is introduced into the inner rotary drum 6 and the outer rotary drum 7 via the supply unit 3, broken, dried, and entirely ground by a screw 14.

However, in the above-described garbage drying apparatus, the burner 8 is installed on the outer rotary drum 7 to which the compost is transferred, thereby injecting the direct flame of the burner 8 into the inner rotary drum 6. Therefore, the heat energy cannot be dispersed into the outer rotary drum 7 and the inner rotary drum 6, thereby lowering thermal efficiency being used in drying the compost. Thus, the compost or the food waste introduced into the supply unit 3 cannot be entirely dried and the already dried compost is burned.

Further, the distance between the supply unit 3 and the shaking vanes 4 of the inner rotary drum 6 is long, thereby having a slow speed of transferring the food waste. Therefore, with the conventional garbage drying apparatus, it is difficult to swiftly dry a large quantity of the food waste.

### DISCLOSURE OF THE INVENTION

Therefore, in view of the above problems, an object of the present invention is to provide a garbage drying apparatus comprising a plurality of reflection-protective caps and an energy-saving plate within an inner rotary drum, thereby uniformly dispersing a flame generated from a burner into inner and outer rotary drums, preventing the flame from being in contact with the garbage to be incinerated, and maximizing a drying effect of the garbage with small heat capacity by allowing a hot combustion gas together with the garbage to pass through the cylindrical rotary drums.

Another object of the present invention is to provide a garbage drying apparatus comprising a slant projection formed on the inner surface of the inner rotary drum provided with the supply unit and a protruded transfer screw formed on the inner surface of the inner rotary drum between the slant projection and the shaking vane, thereby swiftly transferring the food waste introduced into the inner rotary drum.

In accordance with a preferred embodiment of the present invention, the above and other objects can be accomplished by the provision of a garbage drying apparatus comprising: an inner rotary drum and an outer rotary drum; a roller rotatably supported by a guide roller formed on one end and driven by a chain belt connected to a motor so as to rotate by being connected to the other end of the outer surface of the outer rotary drum; a plurality of shaking vanes and shaking intercepts individually formed on the inner surfaces of the inner rotary drum and the outer rotary drum; and a discharging outlet for exhausting the dried garbage formed by drying the introduce garbage via a hopper with a heat of a burner, wherein a plurality of reflection-protective caps and energy-saving plates are formed within the inner rotary drum in order to uniformly disperse the flame generated by the burner into the inner rotary drum, and a plurality of sawteeth in a straight line are protruded from the outer surface of the inner rotary drum in the axis direction in order to uniformly grind the food waste falling from the outer rotary drum.

Preferably, a slant projection may be formed on one end of the inner surface of the inner rotary drum in order to smoothly transfer the food waste, and a transfer screw may be protruded between the projection and the shaking vane in order to swiftly transfer the food waste introduced into the inner rotary drum.

Further, preferably, a slant projection may be formed on the other end of the inner surface of the outer rotary drum in order to uniformly transmit the flame generated by the burner to the outer rotary drum.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cross-sectional view of a conventional garbage drying apparatus;

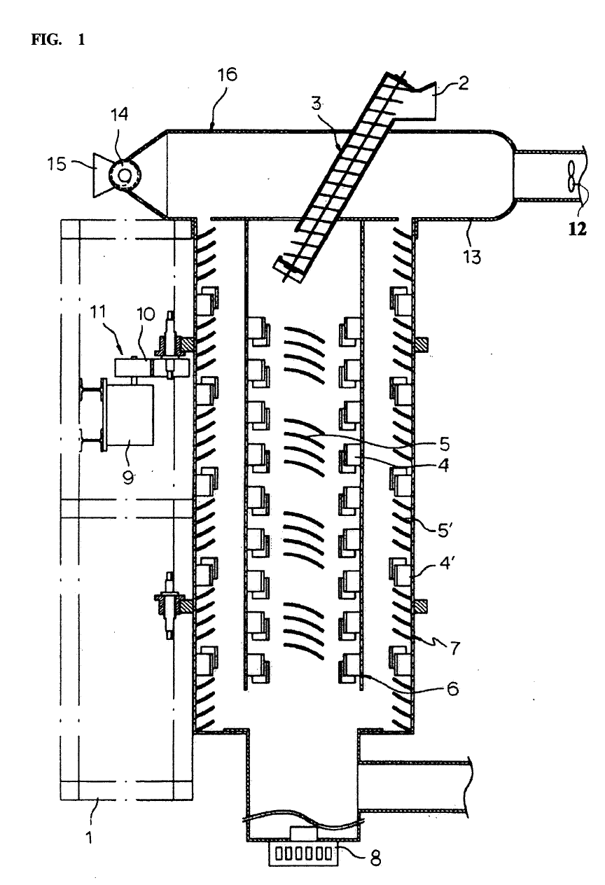

FIG. 2 is a schematic cross-sectional view of a garbage drying apparatus in accordance with an embodiment of the present invention;

FIG. 3 is a cross-sectional view of an inner rotary drum and an outer rotary drum in accordance with the embodiment of the present invention; and

FIG. 4 is a perspective view of the inner rotary drum and the outer rotary drum in accordance with the present invention.

### BEST MODE FOR CARRYING OUT THE INVENTION

Hereinafter, a preferred embodiment of the present invention is described in detail with reference to the accompanying drawings. The embodiment does not limit the scope of the present invention but is only an exemplary.

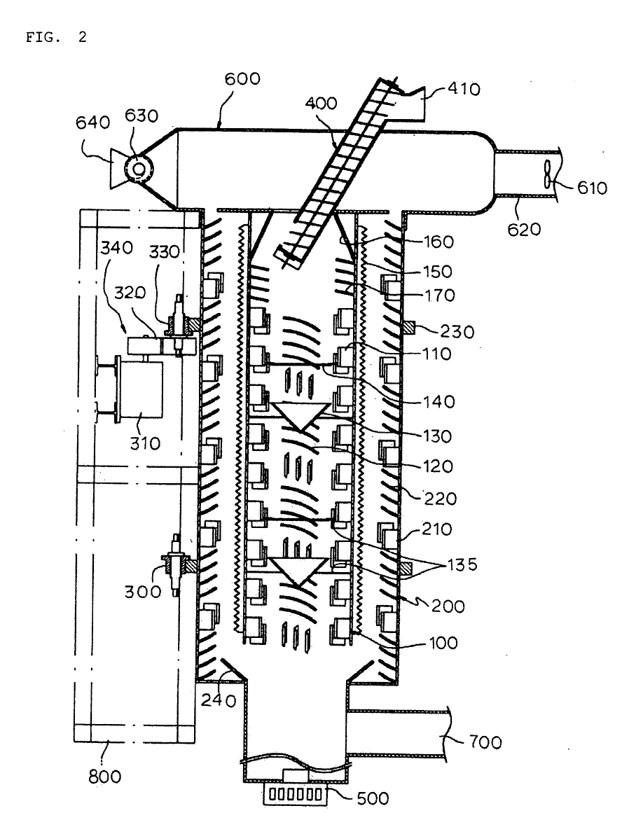

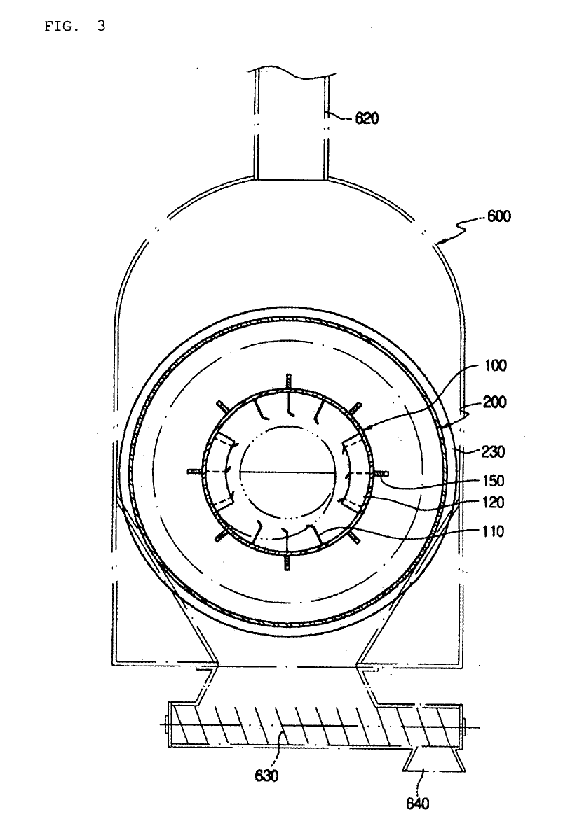

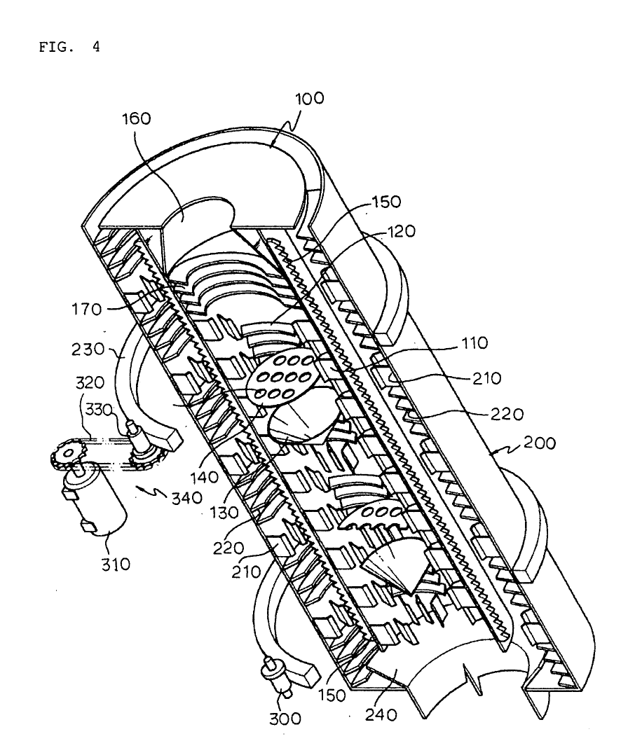

FIG. 2 is a schematic cross-sectional view of a garbage drying apparatus in accordance with an embodiment of the present invention. FIG. 3 is a cross-sectional view of an inner rotary drum 100 and an outer rotary drum 200 in accordance with the embodiment of the present invention, and FIG. 4 is a perspective view of the inner rotary drum 100 and the outer rotary drum 200 in accordance with the present invention. The garbage drying apparatus of the present invention comprises the inner rotary drum 100 and the outer rotary drum 200, a driving means 340 rotatably supported by a guide roller 300 rotated by a roller 330 driven by contacting a chain belt 320 connected to a motor 310 to the other side outer surface 230 of the outer rotary drum 200, a plurality of shaking vanes 110 and 210 and shaking intercepts 120 and 220 individually formed on the inner surfaces of the inner rotary drum 100 and the outer rotary drum 200, an exhaust mean 600 for exhausting combustion gas and garbage formed by drying garbage introduced into a hopper 410 of a supply unit 400 by hot air of a burner 500. In this garbage drying apparatus, in order to uniformly disperse the flame generated by the burner 500 into the inner rotary drum 100, a plurality of reflection-protective caps 130 and energy-saving plates 140 are formed within the inner rotary drum 100 by a plurality of supporters 135. Herein, the connections between one ends of the reflection-protective caps 130 and the energy-saving plates 140 and the inner surface of the inner rotary drum 100 may be carried out by a conventional welding method.

The inner rotary drum 100 is firmly fixed to the inner wall of the outer rotary drum 200 by the welding (not shown) or the screw coupling of the supporter. Therefore, when the outer rotary drum 200 rotates in a designated direction by the driving means 340, the inner rotary drum 100 also rotates in the same direction.

The reflection-protective cap 130 is cone-shaped, and its angular point is opposite to the flame generated from the burner 500, thereby uniformly diffusing the flame generated from the burner 500 into the inner surface of the inner rotary drum 100.

Further, the energy-saving plate 140 is plate-shaped, and a plurality of through holes 141 are formed on the energy-saving plate 140.

In order to uniformly grind the food waste fallen from the outer rotary drum 200, a plurality of sawteeth in a straight line are protruded from the outer surface of the inner rotary plate 100 in the axis direction.

In order to smoothly transfer the food waste, a slant projection 160 is formed on one end of the inner surface of the inner rotary drum 100. In order to swiftly transfer the food waste introduced into the inner rotary drum 100, a transfer screw 170 is protruded between the projection 160 and the shaking vane 110.

In order to uniformly transmit the flame generated by the burner 500 to the outer rotary drum 200, a slant projection 240 is formed on the other end of the inner surface of the outer rotary drum 200. A function of the garbage driving apparatus in accordance with the embodiment of the present invention is described below.

First, in viewing the flow of the garbage, the food waste and the compost are injected via the hoper 41 of the supply unit 400 installed on the flame 600. When the outer rotary drum 200 and the inner rotary drum 100 rotate in the same direction by allowing the roller 330 driven by the chain belt 320 connected to the motor 310 of the driving means 340 to be in contact with the outer surface of the other end of the outer surface of the outer rotary drum 200, the food waste introduced via the supply unit 400 passes through the transfer screw 170 of the inner rotary drum 100, is successively mixed and transferred by the shaking vanes 110 and the shaking intercepts 120, and falls from the end of the inner rotary drum 100 to the outer rotary drum 200. Then, the food waste is successively mixed by the shaking vanes 210 and the shaking intercepts 220 of the outer rotary drum 200, and falls into the sawteeth 150 of the inner rotary drum 100 and ground. The ground food waste falls from the end of the outer rotary drum 200 to the exhaust means 600, and is entirely ground by the screw 630 and discharged into the outside via the exhaust outlet 640.

Secondly, in viewing the flow of the flame generated from the burner 500, the flame generated from the burner 500 disperses the food waste introduced into the inner rotary drum 100 via the supply unit 400 into the inner surface of the inner rotary drum 100 via the reflection-protective cap 130, thereby drying the food waste. That is, the flow of the heat is slow by the through holes 141 of the energy-saving plate 140, thereby saving the energy and effectively drying the food waste. Then, the flame generated from the burner 500 passes through the slant projection 240 of the outer rotary drum 200 and is uniformly dispersed into the inner surface of the outer rotary drum 200, thereby entirely drying the food waste falling from the inner rotary drum 100 to the outer rotary drum 200. Herein, the combustion gas generated by drying the food waste is discharged into the exhaust pipe 520 by the fan 610.

The heat generated from the burner 500 is transferred via the exhaust can 700 installed on the upper surface of the burner 500, thereby being reused.

### INDISTRIAL APPLICABILITY

As described above, the garbage drying apparatus of the present invention comprises a slant projection formed on one end of the inner surface of the inner rotary drum and the transfer screw protruded from the inner surface of the inner rotary drum between the slant projection and the shaking vane, thereby swiftly transferring the food waste introduced into the inner rotary drum as well as smoothly transferring the food waste.

Further, the garbage drying apparatus of the present invention comprises a plurality of the reflection-protective caps and the energy-saving plates formed on the inner surface of the inner rotary drum, thereby uniformly dispersing the flame generated from the burner into the inner surfaces of the inner rotary drum and the outer rotary drum, preventing the flame from being in contact with the garbage to be incinerated, and maximizing a drying effect of the garbage with small heat capacity to save the energy.

Moreover, the garbage drying apparatus of the present invention comprises a plurality of the sawteeth in a straight line protruded from the outer surface of the inner rotary drum in the axis direction, thereby uniformly grinding the food waste falling from the outer rotary drum.

Finally, the garbage drying apparatus of the present invention comprises the slant projection formed on the other end of the inner surface of the outer rotary drum, thereby uniformly transmitting the flame generated from the burner into the inner surface of the outer rotary drum and maximally drying the food waste to prevent the waste-water or the sewage from the undried food waste.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A garbage drying apparatus comprising:
an inner rotary drum and an outer rotary drum;
a roller rotatably supported by a guide roller formed on one end and driven by a chain belt connected to a motor so as to rotate by being connected to the other end of the outer surface of the outer rotary drum;
a plurality of shaking vanes and shaking intercepts individually formed on the inner surfaces of the inner rotary drum and the outer rotary drum; and
a discharging outlet for exhausting the dried garbage formed by drying the introduce garbage via a hopper with a heat of a burner,
wherein a plurality of reflection-protective caps 130 and energy-saving plates 140 are formed within the inner rotary drum 100 in order to uniformly disperse the flame generated by the burner 500 into the inner rotary drum 100 and a plurality of sawteeth 150 in a straight line are protruded from the outer surface of the inner rotary drum 100 in the axis direction in order to uniformly grind the food waste falling from the outer rotary drum 200.

2. The garbage drying apparatus as set forth in claim 1, wherein a slant projection 160 is formed on one end of the inner surface of the inner rotary drum 100 in order to smoothly transfer the food waste, and a transfer screw 170 is protruded between the projection 160 and the shaking vane 110 in order to swiftly transfer the food waste introduced into the inner rotary drum 100.

3. The garbage drying apparatus as set forth in claim 1, wherein a slant projection 240 is formed on the other end of the inner surface of the outer rotary drum 200 in order to uniformly transmit the flame generated by the burner 500 to the outer rotary drum 200.

4. The garbage drying apparatus as set forth in claim 1, wherein the energy-saving plate 140 is plate-shaped, and a plurality of through holes 141 are formed on the energy-saving plate 140.
